(19) United States
(12) Patent Application Publication
(10) Pub. No.: US 2015/0319037 A1
(43) Pub. Date: Nov. 5, 2015

(54) METHOD AND SYSTEM FOR VIRTUALIZING LAYER-3 (NETWORK) ENTITIES

(71) Applicant: ZTE (USA) INC., Richardson, TX (US)

(72) Inventor: Bhumip KHASNABISH, Lexington, MA (US)

(21) Appl. No.: 14/651,868

(22) PCT Filed: Dec. 10, 2013
(86) PCT No.: PCT/US2013/073970

§ 371 Date: Jun. 12, 2015

Related U.S. Application Data
(60) Provisional application No. 61/736,894, filed on Dec. 13, 2012.

(51) Int. Cl. H04L 12/24; G06F 9/455

(52) U.S. Cl. CPC H04L 41/0803; G06F 9/455

(57) ABSTRACT

A method for virtualizing the commonly used network (ISO layer-3) entities is described. The entities include router, routing/topology database, firewall, load balancer, etc. The virtualization paradigm helps network-aware services and devices to be more effective, and it is equally attractive for service-/device-aware networks. In terms of using the network entities, the Applications and Services can utilize either virtual entities or physical entities or a combination of both in order to gracefully support service experience, overload and faults, seamlessly.

### FIELD OF THE INVENTION

The present invention describes a mechanism for virtualizing the network layer entities. These entities include router, routing/topology database, firewall, load balancer, etc. Many other devices that offer value-added layer-3 services can be also considered as network layer entities. These may include Compute, storage, link/channel, routing and forwarding table/engine, firewall, policy/service-quality manager, loan balancer/distributor, etc. The process of virtualization will make feasible the creation, utilization, and mobility of the following entities across a network:
(Virtualized) network port
(Virtualized) network link
(Virtualized) forwarding table
(Virtualized) DNS
(Virtualized) load balancer
(Virtualized) AAA server
(Virtualized) routing engine
(Virtualized) value-added networked service entities

### BACKGROUND OF THE INVENTION

Present day process of virtualization of network entities is mostly concerned with layer-2 based mechanism and services. For example, DMTF's virtualization management initiative developed a set of specifications to address the management lifecycle of a virtual environment. The open virtualization format or OVF provides a standard format for packaging and describing virtual machines and applications for deployment across heterogeneous platforms. The other specs cover virtualization of (a) Ethernet port, (b) Memory resource, (c) Processor resource, and (d) Storage resource.

We note that any attention to the network layer entities is visibly missing. While layer-2 domain cover typical broadcast domain over small (room, campus, a small city, etc.) geographical area, network layer covers a wide (big city, state, country, and beyond) geographical area and hence is more attractive for automated load balancing and disaster recovery.

### SUMMARY OF THE INVENTION

Virtualization of layer-3 entities extends the benefits of virtualization mechanism that is commonly used in layer-2 domain over a broadcast (local area network or LAN) domain. However, since it is done over layer-3, the scope extends over a wider geographical area.

This opens up the possibility of effectively developing wide-area network-aware services and devices, and similarly service-/device-aware networks.

In other aspects, the invention provides a system and a computer program having features and advantages corresponding to those discussed above.

The objectives of the present invention will become apparent upon reading the following description and upon reference to the accompanying drawings.

It is to be understood that the foregoing general description and the following drawings and detailed description are exemplary and explanatory and are intended to provide further explanation of the invention as claimed.

### BRIEF DESCRIPTION OF THE DRAWINGS

Having thus described the invention in general terms, reference is now be made to the accompanying drawings, which are not necessarily drawn to scale. The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

In the drawings:

FIG. 1 shows a high-level schematic for abstracting (virtualizing) network (layer-3) entities.

FIG. 2, Control and Management of Virtualized Network Entities, illustrates how virtualized network entities can be controlled and managed by the applications and services.

FIG. 3, Construction of an Appliance using Virtualized Network Entities, demonstrates how an appliance can be constructed using virtualized layer-3 entities.

### DETAILED DESCRIPTION

The present inventions now will be described more fully hereinafter with reference to the accompanying drawings. It is to be understood that the figures and descriptions provided herein may have been simplified to illustrate elements that are relevant for a clear understanding of the present invention, while eliminating, for the purpose of clarity, other elements found in typical systems for virtualizing layer-3 (network) entities and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art of optical network operation.

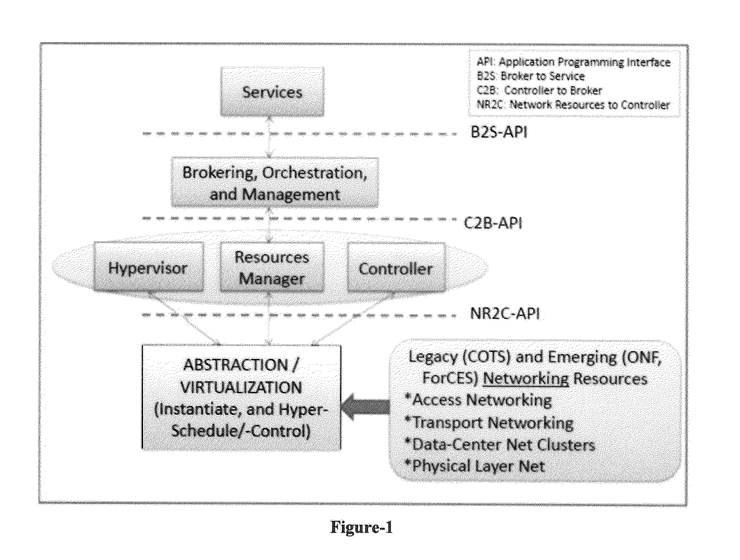

FIG. 1 shows a high-level schematic for abstracting (virtualizing) network entities.

The process of virtualization includes creating an instance of the layer-3 (network) entity according to a pre-specified configuration and managing (allocating, maintaining, and releasing) its use over a pre-scheduled time duration for a specific application/service.

It may be required to utilize a profile/configuration database in order to accelerate the selection of configuration. In addition, a management client can be used for managing the assignment and release of a virtual network entity (VNE) for any application and service. It is possible to use standard web-based interface for management client as well. For example, IETF's NetConf (Network Configuration Protocol (NETCONF), RFC6241, lookup the web link at tools.ietf.org/html/rfc6241) protocol can be used for VNE management related operations.

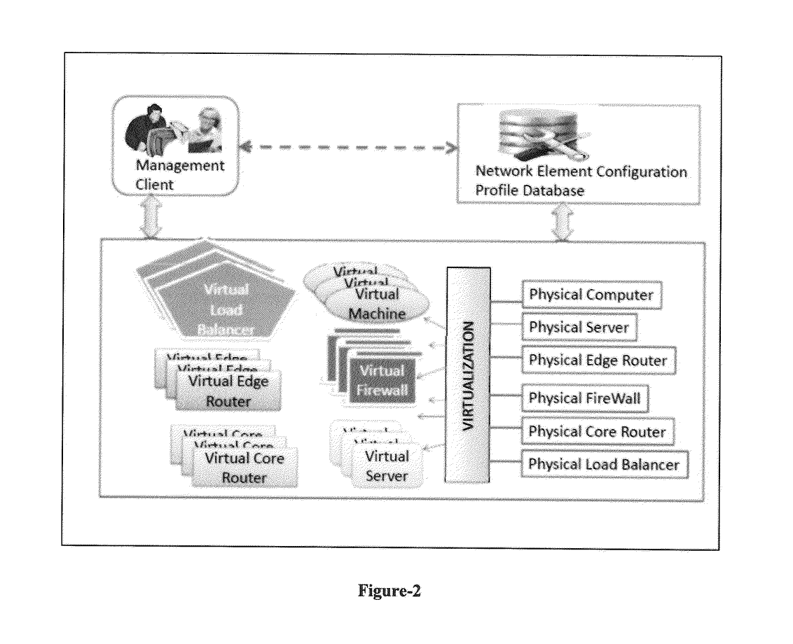

FIG. 2 illustrates how virtualized network entities can be controlled and managed by the applications and services.

If an application/service requires VNE form multiple independently operated domains, it may be required to use a broker or orchestrator between application/service and the VNE controller, as shown in FIG. 1.

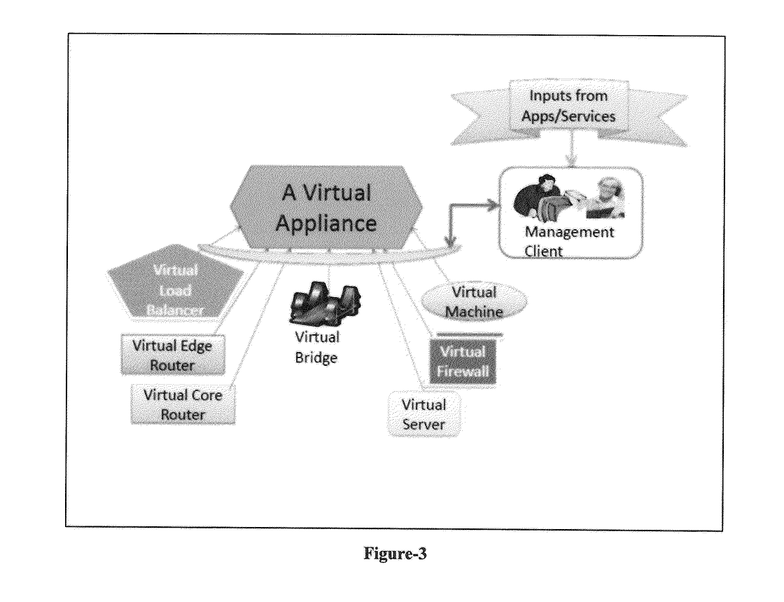

FIG. 3 demonstrates how an appliance can be constructed using virtualized layer-3 entities. The VNEs that are used in the appliance may reside in one physical device (simplest case), multiple physical devices under one administrative domain, or in multiple geographically dispersed domains under multiple administrative domains (worst case). The issues related to privacy, security, quality-of-service and service level agreement must be carefully addressed when VNEs from multiple administrative domains are utilized by an application/service.

Although specific terms are employed herein, they are used in a generic and descriptive sense only and not for purposes of limitation. Also, the invention has been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the claims.

What is claimed:

1. A method of virtualizing network entities comprising:
creating an instance of a layer-3 (network) entity according to a pre-specified configuration; and
managing use of the instance over a pre-scheduled time duration for an application or service.

2. The method of claim 1, wherein managing the use of the instance comprises allocating, maintaining, and releasing.

3. The method of claim 1, further comprising using a profile or configuration database to accelerate a selection of the configuration.

4. The method of claim 1, further comprising using a management client for managing assignment and release of one or more virtual network entities for the application or service.

5. The method of claim 4, wherein the management client is a standard web-based interface.

6. The method of claim 4, wherein the management client is Network Configuration Protocol, RFC 6241.

7. The method of claim 4, wherein the one or more virtual network entities are from multiple independently operated domains.

8. The method of claim 7, further comprising using (i) a broker or orchestrator between the application or service and (ii) a virtual network entity controller.

9. The method of claim 4, wherein the one or more virtual network entities reside in one physical device.

10. The method of claim 4, wherein the one or more virtual network entities reside in multiple physical devices.

11. The method of claim 4, wherein the one or more virtual network entities reside in multiple geographically dispersed domains under multiple administrative domains.

12. The method of claim 1, wherein the network entities include one or more of a router, a routing/topology database, a firewall, and a load balancer.

13. The method of claim 1, wherein the network entities include one or more devices that offer value-added layer-3 services.

14. A system of virtualizing network entities comprising:
means for creating an instance of a layer-3 (network) entity according to a pre-specified configuration; and
means for managing use of the instance over a pre-scheduled time duration for an application or service.

15. The system of claim 14, wherein the means for managing use of the instance comprises means for allocating, means for maintaining, and means for releasing.

16. The system of claim 14, further comprising means for using a profile or configuration database to accelerate a selection of the configuration.

17. The system of claim 14, further comprising means for using a management client for managing assignment and release of one or more virtual network entities for the application or service.

18. The system of claim 17, wherein the management client is a standard web-based interface.

19. The system of claim 17, wherein the management client is Network Configuration Protocol, RFC 6241.

20. The system of claim 17, wherein the one or more virtual network entities are from multiple independently operated domains.

21. The system of claim 20, further comprising means for using a broker or orchestrator between (i) the application or service and (ii) a virtual network entity controller.

22. The system of claim 17, wherein the one or more virtual network entities reside in one physical device.

23. The system of claim 17, wherein the one or more virtual network entities reside in multiple physical devices.

24. The system of claim 17, wherein the one or more virtual network entities reside in multiple geographically dispersed domains under multiple administrative domains.

25. The system of claim 14, wherein the network entities include one or more of a router, a routing/topology database, a firewall, and a load balancer.

26. The system of claim 14, wherein the network entities include one or more devices that offer value-added layer-3 services.

27. An article of manufacture including a computer-readable medium having instructions stored thereon for virtualizing network entities, comprising:
Instructions for creating an instance of a layer-3 (network) entity according to a pre-specified configuration; and
Instructions for managing use of the instance over a pre-scheduled time duration for an application or service.

28. The article of manufacture of claim 27, wherein instructions for managing the use of the instance comprises instructions for allocating, instructions for maintaining, and instructions for releasing.

29. The article of manufacture of claim 27, further comprising instructions for using a profile or configuration database to accelerate a selection of the configuration.

30. The article of manufacture of claim 27, further comprising instructions for using a management client for managing assignment and release of one or more virtual network entities for the application or service.

31. The article of manufacture of claim 30, wherein the management client is a standard web-based interface.

32. The article of manufacture of claim 30, wherein the management client is Network Configuration Protocol, RFC 6241.

33. The system of claim 30, wherein the one or more virtual network entities are from multiple independently operated domains.

34. The article of manufacture of claim 33, further comprising instructions for using a broker or orchestrator between (i) the application or service and (ii) a virtual network entity controller.

35. The article of manufacture of claim 30, wherein the one or more virtual network entities reside in one physical device.

36. The article of manufacture of claim 30, wherein the one or more virtual network entities reside in multiple physical devices.

37. The article of manufacture of claim 30, wherein the one or more virtual network entities reside in multiple geographically dispersed domains under multiple administrative domains.

38. The article of manufacture of claim 27, wherein the network entities include one or more of a router, a routing/topology database, a firewall, and a load balancer.

39. The system of claim 27, wherein the network entities include one or more devices that offer value-added layer-3 services.
